(19) United States
(12) Patent Application Publication
(10) Pub. No.: US 2010/0307473 A1
(43) Pub. Date: Dec. 9, 2010

(54) DIAMOND TOOL

(75) Inventors: Hyun Woo Lee, Incheon (KR); Jong Hwan Park, Seoul (KR); Sung Kun Lee, Chungju-si (KR); Dae Geun Kim, Seoul (KR)

Correspondence Address: SEED INTELLECTUAL PROPERTY LAW GROUP PLLC, 701 FIFTH AVE, SUITE 5400, SEATTLE, WA, 98104, US

(73) Assignee: SHINHAN DIAMOND IND CO., LTD., Incheon (KR)

(21) Appl. No.: 12/515,275

(22) PCT Filed: Apr. 24, 2007
(86) PCT No.: PCT/KR07/01988

§ 371 Date: Aug. 6, 2010

(30) Foreign Application Priority Data
Nov. 16, 2006 (KR) 10-2006-0113540

(51) Int. Cl. B23D 61/02

(52) U.S. Cl. 125/15

(57) ABSTRACT

The present invention relates to a diamond tool for cutting a workpiece. An object of the present invention is to provide a diamond tool, wherein diamond granules are arranged at regular intervals with respect to an outer peripheral surface of a segment so that the diamond granules are uniformly arranged in a front face of the segment, which is a substantial cutting surface, thereby improving the cutting performance thereof and simultaneously maintaining a consistent performance during the service life of the diamond tool. A diamond tool of the present invention for achieving the object has a segment that is attached to an outer peripheral surface of a shank in the form of a wheel or plate and contains diamond granules, wherein the segment comprises a plurality of diamond granules arranged on a plurality of concentric circles having the same central axis as an outer periphery of the segment.

### BACKGROUND

1. Technical Field

The present invention relates to a diamond tool for cutting a work piece, and more particularly, to a diamond tool in which diamond granules included in a segment attached to a shank of the diamond tool are arranged at regular intervals with respect to an outer peripheral surface of the segment.

2. Description of the Related Art

FIG. 1 is a plan view showing a typical diamond tool.

As shown in FIG. 1, the diamond tool 10 that is a tool for cutting or grinding a surface of a work piece generally includes a shank 12 that takes the shape of a wheel or disk to machine an inner diameter or inner surface or an outer or inner race of a work piece and is to be coupled to a grinding machine and segments 14 attached to an outer periphery of the shank 12 to cut a work piece.

Each of the segments 14 comprises a binder 16 in the form of paste and diamond granules 15 irregularly dispersed in the binder 16. A mixture of the binder 16 and the diamond granules 15 are placed in a mold with a predetermined shape and then subjected to heat and pressure so that the mixture can be sintered and dried.

The aforementioned manufacturing process has an advantage in that the segments 14 can be easily manufactured. However, deviations in the products may occur according to the distributed state of the diamond granules 15 and there may be a case where an insufficient or excessive amount of diamond granules 15 is contained in the binder 16.

Therefore, in order to solve these problems, U.S. Pat. No. 2,194,546 discloses a technique for arranging diamond granules 15 in a pattern with a regular interval. When the diamond granules 15 are arranged in a certain pattern, overuse of the diamond granules 15 can be prevented, thereby reducing manufacturing costs. Further, the regular arrangement of the diamond granules 15 leads to improvement in the product performance and to reduction in the performance deviation, thereby resulting in improved reliability of the products.

As described above, methods of arranging the diamond granules 15 in a certain pattern have been actively attempted since early 1990s, and examples thereof are disclosed in U.S. Pat. Nos. 4,925,457, 5,092,910, 5,049,165 and the like. In these methods, a wire mesh or a network screen in which diamond granules will be arranged regularly is placed on a flexible carrier formed of a thermoplastic binder 16 and metallic fibers or a mixture thereof, and the diamond granules 15 are then forcibly inserted into openings of the wire mesh or network screen.

Meanwhile, there has been recently developed a diamond tool in which diamond particles are arranged in segments 14 in a lattice pattern as disclosed in Korean Patent No. 597, 717.

FIGS. 2(a) and (b) show conventional segments for a diamond tool. Such a diamond tool 20 includes segments 24 formed by arranging diamond granules in a lattice pattern using a wire mesh or a perforated plate and fixing the diamond granules using a binder 26. In this diamond tool 20, the diamond granules may be arranged in a certain regular pattern as shown in FIG. 2(a), or in a pattern in which the diamond granules are tilted by a certain angle α as shown in FIG. 2(b). Here, in arranging the diamond granules 25 in a lattice pattern tilted by a certain angle, the tilted angle of the lattice is determined according to the radius of a tool in consideration of the radius of a cutting tool.

However, the conventional diamond tool is typically manufactured in a rotating disk form. Thus, the lattice-patterned arrangement that results from a conventional method without considering a π-value associated with a radius has a problem in that the diamond granules cannot be uniformly arranged in a front face of a segment, which is a substantial cutting surface.

### BRIEF SUMMARY

According to one embodiment of the present invention is a diamond tool has diamond granules are arranged at regular intervals with respect to an outer peripheral surface of a segment so that the diamond granules are uniformly arranged in a front face of the segment, which is a substantial cutting surface. This provides for improving the cutting performance thereof and simultaneously maintaining a consistent performance during the service life of the diamond tool.

A diamond tool according to one embodiment of the present invention for achieving the object has a segment that is attached to an outer peripheral surface of a shank in the form of a wheel or plate and contains diamond granules, wherein the segment comprises a plurality of diamond granules arranged on a plurality of concentric circles having the same central axis as an outer periphery of the segment.

A diamond tool according to another aspect of the present invention for achieving the object has a segment that is attached to an outer peripheral surface of a shank in the form of a wheel or plate and contains diamond granules, wherein the segment comprises a plurality of diamond granules arranged on a plurality of parallel circles that are in parallel to an outer periphery of the segment.

Diamond granules arranged on an identical concentric circle among the diamond granules of the segment may be arranged at regular intervals. Alternatively, the diamond granules may be arranged in the segment such that a region to be cut by diamond granules arranged on a leading concentric circle partially overlaps with a region to be cut by diamond granules arranged on an adjacent following concentric circle. At this time, the region to be cut by the diamond granules arranged on the leading concentric circle may overlap with the region to be cut by the diamond granules arranged on the adjacent following concentric circle at a ratio of 40 to 70%.

### BRIEF DESCRIPTION OF THE SEVERAL VIEWS OF THE DRAWINGS

The above and other objects, features and advantages of the present invention will become apparent from the following description of preferred embodiments given in conjunction with the accompanying drawings, in which:

FIG. 1 is a plan view showing a typical diamond tool;

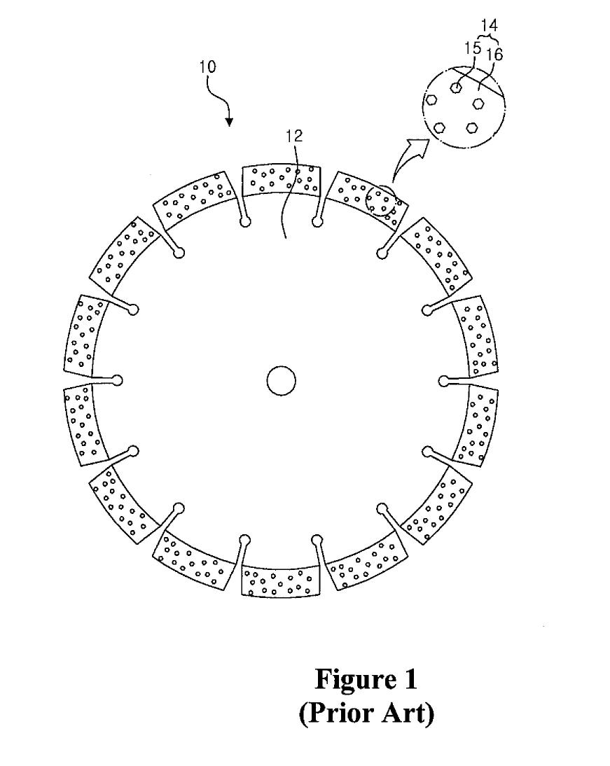

FIGS. 2(a) and (b) show conventional segments for a diamond tool;

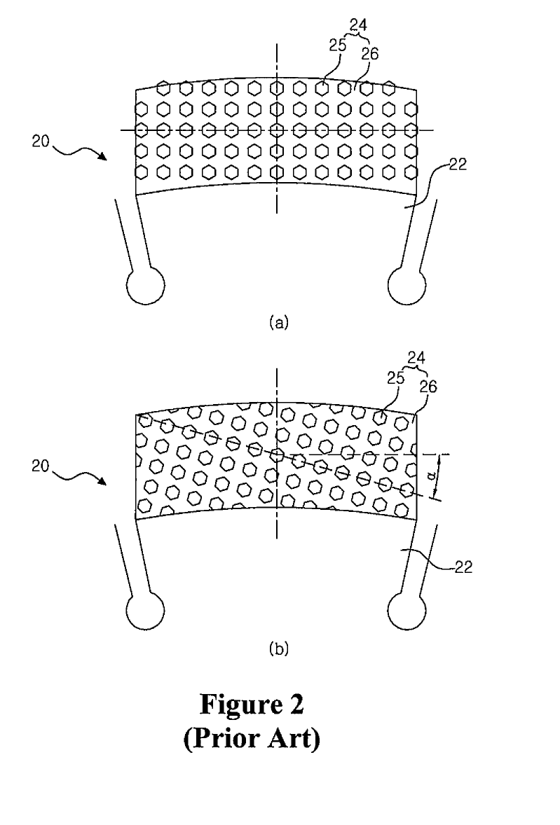

FIG. 3 is a front view of a diamond tool according to one embodiment of the present invention;

FIGS. 4 and 5 are enlarged perspective and front views of segments for the diamond tool according to one embodiment of the present invention, respectively;

FIG. 6 is a front view showing another arrangement of diamond granules in a segment of the diamond tool according to one embodiment of the present invention;

FIG. 7 is an enlarged view of a segment of a diamond tool according to one embodiment of the present invention; and

FIG. 8 is an enlarged view of a segment of a diamond tool according to another embodiment of the present invention.

### DETAILED DESCRIPTION

Hereinafter, embodiments of the present invention will be described in detail with reference to the accompanying drawings.

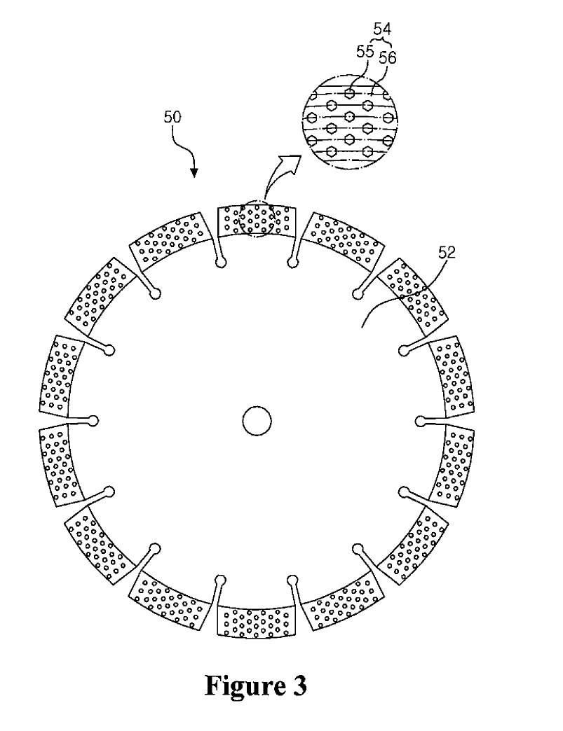

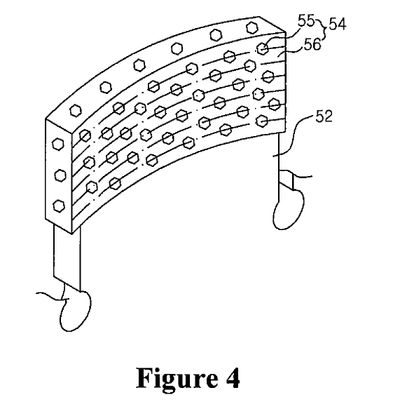

FIG. 3 is a front view of a diamond tool according to one embodiment of the present invention, and FIGS. 4 and 5 are enlarged perspective and front views of segments for the diamond tool according to one embodiment of the present invention, respectively.

As shown in FIGS. 3 to 5, the diamond tool 50 of the present invention includes a shank 52 that takes the shape of a wheel or disk and is to be combined to a grinding machine. The shank 52 has slots with a desired length radially formed in an outer peripheral area toward a central shaft of the shank. Each of segments 54 including a plurality of diamond granules 55 is attached between adjacent ones of the slots of the shank 52. At this time, the segments 54 may be fabricated separately from the shank 52 and then attached to the shank 52, or may be formed directly on the surface of the shank 52.

Here, inner peripheries of the segments 54 have the same curvature as an outer periphery of the shank 52. The overall shape defined by outer peripheries of the segments is a circular shape like the central shaft of the shank 52.

In addition, the segment 54 may be formed such that front and rear faces substantially in charge of cutting are in parallel with each other as shown in FIG. 5(a) or have slopes identical with those of lines extending from the slots as shown in FIG. 5(b).

Further, a plurality of diamond granules 55 attached to each of the segments 54 are arranged on a plurality of concentric circles that have the same central axis as the outer periphery of the segment 54 and are preferably arranged at regular intervals. That is, in the diamond tool 50, there are imaginary circles which are defined by arrangements of the diamond granules 55 and have various radii that are reduced at regular intervals toward an inner side of the diamond tool.

Meanwhile, as the diamond tool 50 is used, the segment 54 is worn out and outer diamond granules 55 come off therefrom. Even in the circumstances where the radius of an imaginary circle defined by diamond granules arranged at an outermost portion is gradually reduced, diamond granules 55 in the front face of the segment substantially responsible for a cutting operation are always maintained in an arrangement state with a consistent pattern.

In addition, among the diamond granules 55 attached to the segment 54, diamond granules 55 arranged on the same concentric circle are arranged to have constant spacing from one another. Further, in the segment 54, the diamond granules 55 may be arranged such that diamond granules arranged on a following concentric circle are placed at regular intervals between diamond granules arranged on a leading concentric circle.

That is, diamond granules 55 are arranged at regular intervals on a leading concentric circle. Then, diamond granules 55 arranged on a following adjacent concentric circle are arranged between adjacent ones of diamond granules 55 on the leading concentric circle. At this time, the diamond granules 55 on the following concentric circle may be arranged at middle positions of the adjacent ones of the diamond granules on the leading concentric circle.

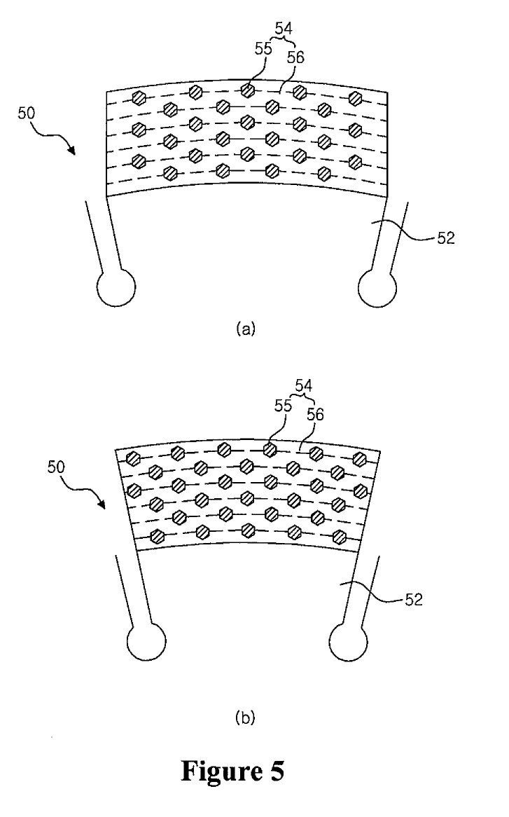

FIG. 6 is a front view showing another arrangement of diamond granules in a segment of the diamond tool according to the present invention.

Referring to FIG. 6, between adjacent ones of diamond granules 155 on a leading concentric circle in the segment 154, diamond granules 155 on a directly following concentric circle and diamond granules 155 on further following concentric circles are arranged at regular intervals. The diamond granules may be attached to the segment 154 using a binder 156.

In addition, the segment 154 cuts a work piece in such a manner that leading diamond granules arranged on the outermost concentric circle first cut the work piece and following diamond granules on an inner concentric circle adjacent thereto then cut the work piece.

Here, it is preferred that an area to be cut by the leading diamond granules partially overlap with an area to be cut by the following diamond granules adjacent thereto.

Since the area to be cut by the leading diamond granules 55 partially overlaps with the area to be cut by the following diamond granules as described above, cutting can be performed by the following diamond granules even though the leading diamond granules have come off due to use of the diamond tool 150. Further, since the leading and following diamond granules partially overlap with each other, loads exerted on the following diamond granules can be reduced and the following diamond granules can more accurately cut a surface of a work piece.

Preferably, the leading and following diamond granules overlap with each other at a ratio of 40 to 70%.

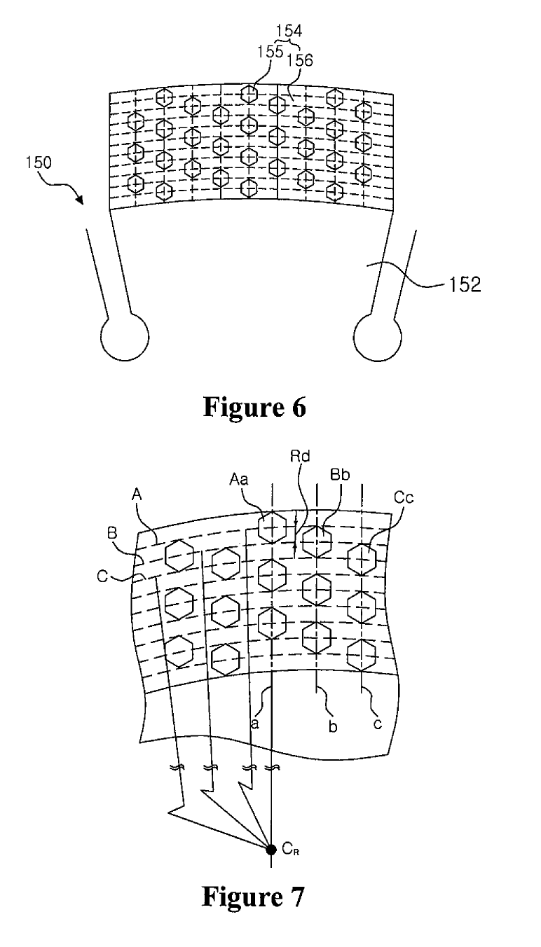

Hereinafter, a more specific description will be made with reference to FIG. 7 that is an enlarged view of a segment of a diamond tool according to one embodiment of the present invention.

The segment is attached to an outer peripheral surface of a shank. Outer peripheries of the segments define a circle as a whole.

In the segment, diamond granules Aa, Bb, Cc, . . . are attached to respective intersections between lines A, B, C, . . . defining concentric circles and lines a, b, c, . . . disposed at regular intervals. Here, the diamond granules Aa, Bb, Cc, . . . are arranged to overlap with one another over certain regions. Each of the overlapping regions is determined by a distance difference Aa-Bb or Bb-Cc between the adjacent diamond granules, i.e., a radius difference ‘R_{d}’ between adjacent concentric circles. (Here, C_{R} denotes a center of lines A, B, C, . . . defining the respective concentric circles and the radii of lines A, B, C, . . . sequentially decrease by ‘R_{d}’.)

In order to control the overlapping ratio between the leading and following diamond granules, each ‘R_{d}’ should be controlled. Accordingly, the radii of the plurality of concentric circles on which the diamond granules are arranged are determined.

Although the diamond granules have been described by way of example in connection with lines A, B, and C defining the concentric circles, the present invention is not limited thereto. The intervals at which the diamond granules are arranged are applied to the entire surface of the segment.

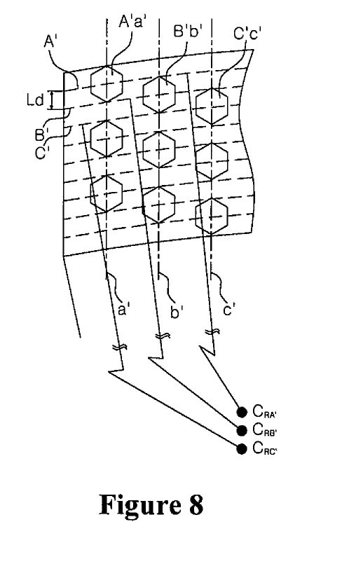

In this embodiment, the diamond tool has been described in connection with the case where the diamond granules of the segment are arranged on a plurality of concentric circles having a constant difference between the radii of adjacent concentric circles. However, in order to improve the manufacture and productivity of the diamond tool, the diamond granules may be arranged on circles with an identical radius, as shown in FIG. 8.

FIG. 8 is an enlarged view of a segment of a diamond tool according to another embodiment of the present invention.

Referring to FIG. 8, the segment is attached to an outer peripheral surface of a shank in the form of a wheel or disk, and outer peripheries of the segments define a circle as a whole.

In addition, diamond granules attached to the segment are arranged on a plurality of parallel circles that are in parallel to the outer periphery of the segment.

At this time, the plurality of parallel circles on which the diamond granules are arranged have an identical radius and are arranged at regular intervals to be far away from the outer periphery of the segment.

That is, as shown in FIG. 8, diamond granules A′a′, B′b′, C′c′, . . . are attached at respective intersections between lines A′, B′, C′, . . . in parallel to the outer periphery of the segment 254 and lines a′, b′, c′, . . . disposed at regular intervals. Here, the diamond granules A′a′, B′b′, C′c′, . . . are arranged to overlap with one another over certain regions. Each of the overlapping regions is determined by a distance difference ‘L_{d}’ between adjacent parallel circles defined by the diamond granules. (Here, C_{RA′}, C_{RB′}, C_{RC′} and the like denote centers of lines A′, B′, C′, . . . defining the respective parallel circles, the radii of lines A′, B′, C′, . . . are the same, and the distance between the centers is denoted by ‘L_{d}’.)

Meanwhile, in order to control the overlapping ratio between the leading and following diamond granules, a distance difference A′a′-B′b′ or B′b′-C′c′ between the adjacent diamond granules, i.e., a distance difference ‘L_{d}’ between the respective parallel circles should be controlled.

According to the diamond tool of the present invention constructed as above, diamond granules are uniformly arranged in the front face of the segment, which is a substantial cutting surface, thereby improving the cutting performance thereof and maintaining a consistent performance during the service life of the diamond tool. In addition, since the leading and following diamond granules cut a region overlapping at a certain ratio, loads exerted on the following diamond granules can be reduced and a surface of a work piece can be cut with higher precision.

These operational effects of the diamond granules can be obtained when the diamond granules are arranged to have the same central axis as the outer periphery of the segment. Further, if the diamond tool has a radius larger than a certain value, these effects can be obtained even when the diamond granules are arranged on circles with the same radius as the outer periphery of the segment. As the circles on which the diamond granules are arranged have an identical radius in such a manner, the productivity of the segment can be more improved.

Although the diamond tool of the present invention has been described above with reference to the accompanying drawings, it is not limited to the embodiments descried above and the drawings. It will be apparent to those skilled in the art that various modifications and changes can be made thereto within the scope of the present invention defined by the appended claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A diamond tool comprising:
a shank; and
a segment adjacent to an outer peripheral region of the shank, the segment including a plurality of diamond granules arranged on a plurality of substantially concentric circles having substantially the same central axis as an outer periphery of the segment.

2. A diamond tool comprising:
a shank; and
a segment adjacent to an outer peripheral region of the shank, the segment including a plurality of diamond granules arranged on a plurality of substantially parallel circles that are substantially parallel to an outer periphery of the segment.

3. The diamond tool as claimed in claim 1, wherein diamond granules arranged on an identical concentric circle among the diamond granules of the segment are arranged at regular intervals.

4. The diamond tool as claimed in claim 1, wherein the diamond granules are arranged in the segment such that a region to be cut by diamond granules arranged on a leading concentric circle partially overlaps with a region to be cut by diamond granules arranged on an adjacent following concentric circle.

5. The diamond tool as claimed in claim 4 wherein the region to be cut by the diamond granules arranged on the leading concentric circle overlaps with the region to be cut by the diamond granules arranged on the adjacent following concentric circle at a ratio of 40 to 70%.

6. The diamond tool as claimed in claim 1 wherein the segment is attached to the outer peripheral region of the shank.

7. The diamond tool as claimed in claim 1, wherein the shank is in a form of a wheel or a plate.

8. The diamond tool as claimed in claim 2 wherein the diamond granules arranged on an identical concentric circle among the diamond granules of the segment are arranged at regular intervals.

9. The diamond tool as claimed in claim 2 wherein the diamond granules are arranged in a segment such that a region to be cut by diamond granules arranged on a leading concentric circle partially overlaps with a region to be cut by diamond granules arranged on an adjacent following concentric circles.

10. The diamond tool as claimed in claim 9, wherein the region to be cut by the diamond granules arranged on the leading concentric circle overlaps with the region to be cut by the diamond granules arranged on the adjacent following concentric circle at a ration of 40 to 70%.

11. The diamond tool as claimed in claim 2 wherein the segment is attached to the outer peripheral region of the shank.

12. The diamond tool as claimed in claim 2 wherein the shank is in a form of a wheel or a plate.
